(19) United States
(12) Patent Application Publication
(10) Pub. No.: US 2010/0201654 A1
(43) Pub. Date: Aug. 12, 2010

(54) ELECTRO-OPTICAL APPARATUS, METHOD OF DRIVING THE SAME, AND ELECTRONIC DEVICE

(75) Inventor: Takashi Toyooka, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/704,395

(22) Filed: Feb. 11, 2010

(30) Foreign Application Priority Data
Feb. 12, 2009 (JP) 2009-029922

(51) Int. Cl. G09G 5/00

(52) U.S. Cl. 345/204

(57) ABSTRACT

A method of driving an electro-optical apparatus includes segmenting a time width of a field into a plurality of subfields, the subfields within the field having different widths; and expressing a desired gradation level using a plurality of the subfields by applying an ON level for setting a pixel to an ON state or an OFF level for setting the pixel to an OFF state to the pixel in each subfield, wherein response characteristic data representing response characteristics of the pixel are obtained, and a width of the subfield for setting the pixel to the ON or OFF state is lengthened when the response characteristic data indicate that a response of the pixel is delayed.

### BACKGROUND

1. Technical Field

The present invention relates to a technology for expressing gradation by turning on/off a pixel in each of a plurality of subfields obtained by segmenting a frame.

2. Related Art

In order to perform gradation display in an electro-optical apparatus which includes display devices such as liquid crystal elements or organic electroluminescent devices as pixels, the following technologies have been proposed. Specifically, JP-A-2007-148417 (FIG. 8) discloses a technology of expressing middle gradation by turning on or off pixels (i.e., display devices) in each of a plurality of subfields obtained by segmenting a frame (or field) and changing a time ratio between ON and OFF states in the frame.

However, since a deviation may easily occur in the response characteristics of the pixels due to temperature changes or individual differences, the characteristic actually expressed in response to each instruction on a gradation level may vary. In addition, display quality may be adversely affected.

### SUMMARY

An advantage of some aspects of the invention is to provide a technology of alleviating effects on display quality while middle gradation is displayed by turning on or off pixels in each of a plurality of subfields, even when response characteristics of pixels vary.

According to an aspect of the invention, there is provided a method of driving an electro-optical apparatus, including segmenting a time width of a field into a plurality of subfields, the subfields within the field having different widths, and expressing desired gradation using a plurality of the subfields by applying an ON level for setting a pixel to an ON state or an OFF level for setting the pixel to an OFF state to the pixel in each subfield, the method including: obtaining response characteristic data representing response characteristics of the pixel; and setting a width of the subfield, which makes the pixel to be the ON or OFF state, to be lengthened when the response characteristic data indicate that a response of the pixel is delayed. According to an embodiment of the invention, when the response of the pixel is lowered, the width of a single subfield is lengthened, and then, the widths of other subfields are accordingly changed. As a result, it is possible to alleviate influence on display quality even when the response characteristics of the pixel are changed.

It is preferable that the width of the single subfield is determined based on an optical state obtained by setting the pixel to the ON state for a corresponding subfield and to the OFF state for other subfields or an optical state obtained by setting the pixel to the OFF state for a corresponding subfield and to the ON state for other subfields according to the response characteristics indicated by the obtained response characteristic data. As a result, since the width of a single subfield is changed according to the response characteristics of the pixel, it is possible to alleviate influence on the display quality.

It is preferable that when the obtained response characteristic data indicate that the response of the pixel is delayed, any subfield other than the single subfield among a plurality of the subfields is shortened.

In addition to the method of driving the electro-optical apparatus, the invention may be applicable to an electro-optical apparatus and an electronic device having the corresponding electro-optical apparatus.

### BRIEF DESCRIPTION OF THE DRAWINGS

The invention will be described with reference to the accompanying drawings, wherein like numbers reference like elements.

FIG. 1 is a block diagram illustrating a construction of an electro-optical apparatus according to an embodiment of the invention.

FIG. 2 illustrates a construction of a display panel in the electro-optical apparatus according to an embodiment of the invention.

FIG. 3 illustrates a construction of a frame in the electro-optical apparatus according to an embodiment of the invention.

FIG. 4 illustrates a process of determining a subfield width in the electro-optical apparatus according to an embodiment of the invention.

FIG. 5 is a diagram for describing determination on the subfield width in the electro-optical apparatus according to an embodiment of the invention.

FIG. 6 illustrates a relationship between a subfield width and response characteristics in the electro-optical apparatus according to an embodiment of the invention.

FIG. 7 illustrates a correspondence relationship between gradation levels and ON and OFF states in subfields.

FIG. 8 illustrates a temporal change of scanning lines selected by a scanning line driving circuit according to an embodiment of the invention.

FIG. 9 is illustrates operations of a scanning line driving circuit in the electro-optical apparatus according to an embodiment of the invention.

FIG. 10 illustrates an optical construction of a projector employing the electro-optical apparatus according to an embodiment of the invention.

### DESCRIPTION OF EXEMPLARY EMBODIMENTS

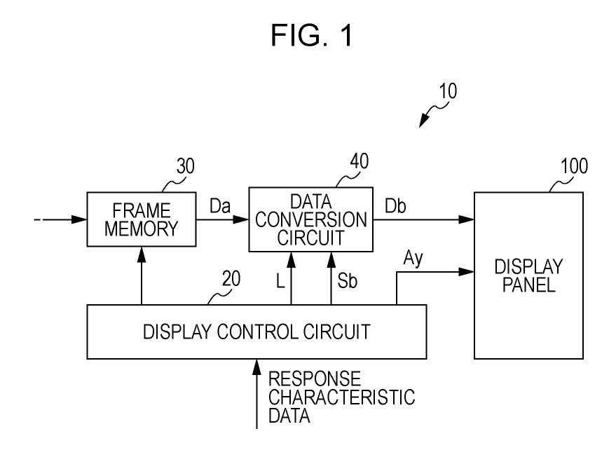

Hereinafter, embodiments of the invention will be described with reference to the accompanying drawings. FIG. 1 is a block diagram illustrating an entire construction of the electro-optical apparatus according to an embodiment of the invention.

Referring to FIG. 1, the electro-optical apparatus 10 includes a display control circuit 20, frame memory 30, a data conversion circuit 40, and a display panel 100 so that the display control circuit 20 controls each unit.

For example, the display panel 100 is an active matrix type, transmissive normally-white mode liquid crystal display panel, which produces a transmission image obtained by modulating a transmittance of each pixel.

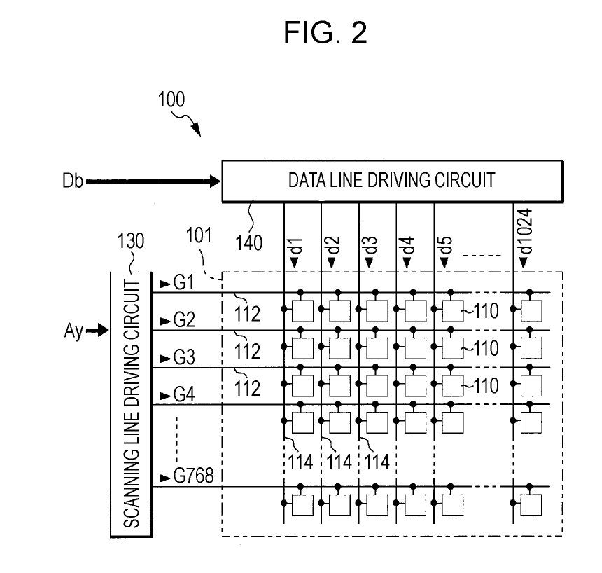

For convenience of description, a construction of the display panel 100 will be described with reference to FIG. 2. Referring to FIG. 2, in a display area 101 of the display panel 100, scanning lines 112 are provided in the 1st, 2nd, 3rd, . . . , 768th rows extending in a horizontal direction in the drawing, and data lines 114 are provided in 1st, 2nd, 3rd, . . . , to 1024th columns extending in a vertical direction in the drawing and electrically insulated from each scanning line 112.

Each pixel 110 is disposed in each intersection between scanning lines 112 of 768 rows and data lines 114 of 1024 columns. Therefore, in the present embodiment, pixels 110 in the display area 101 are arranged in a matrix shape having 768 rows in a vertical direction and 1024 columns in a horizontal direction.

In the vicinity of the display area 101, the scanning line driving circuit 130 and the data line driving circuit 140 are provided.

The data line driving circuit 130 is a sort of address decoder which selects a scanning line designated based on an address signal Ay supplied from the display control circuit 20, sets a scanning signal of a corresponding scanning line to a high level H corresponding to the selection voltage, and sets scanning signals of other scanning lines to a low level L corresponding to a de-selection voltage. Scanning signals supplied to the 1st, 2nd, 3rd, . . . , 768th scanning lines 112 are referred to as G1, G2, G3, . . . , G768, respectively.

Meanwhile, the data line driving circuit 140 supplies the first to 1024th data lines 114 with data signals corresponding to each of the data bit Db. The data signals supplied to the 1st, 2nd, 3rd, . . . , 1024th data lines 114 are referred to as d1, d2, d3, . . . , d1024, respectively.

Although not shown in detail in the drawings, the pixel 110 includes a liquid crystal element having a liquid crystal material interposed between a pixel electrode and a common electrode, and the data signal supplied to the data line 114 is applied to the pixel electrode when the scanning line 112 is selected. In the present embodiment, the data signal has either an ON level corresponding to a data bit “1” or an OFF level corresponding to a data bit “0”. In the normally-white mode, the pixel becomes an ON state (a dark state) when the ON level is applied to the pixel electrode, whereas the pixel becomes an OFF state (a bright state) when the OFF level is applied. Various types of pixels 110, which will be described later, can be employed if they can display a binary value having the ON or OFF state in response to the data bit.

In the present embodiment, the pixel 110 obtains only two states, i.e., ON and OFF states. Therefore, in the present embodiment, gradation is expressed by segmenting a frame which is a unit time into a plurality of subfields and controlling which one of the ON or OFF state is set to the pixel 110 in each subfield so as to change a ratio of a time period occupied by the ON state (or OFF state) for the frame.

Herein, a frame means a time period required to display gradation of a single coma of an image by driving the display panel 100 and is set to 16.7 milliseconds in the present embodiment (when the vertical scanning frequency is 60 Hz).

Returning to FIG. 1, the frame memory 30 has storage areas corresponding to a pixel arrangement of vertical 768 rows×horizontal 1024 columns. Each storage area stores display data Da for designating a gradation level of each corresponding pixel 110. Furthermore, the display data Da is supplied from an upper-layer circuit (not shown) and stored in the storage area of the frame memory 30. Meanwhile, the display data Da corresponding to a single row of pixels that are arranged in the scanning line designated by the address signal Ay are read from the frame memory 30 under the control of the display control circuit 20.

The data conversion circuit 40 converts the display data Da read from the frame memory 30 into a data bit Db for designating the ON or OFF state of the pixel depending on the gradation level to correspond to the subfield notified as the number Sb. In addition, how to designate the ON or OFF state in the pixel according to the gradation level will be described later in conjunction with how to set the time width of each subfield.

Although not shown in detail, the display control circuit 20 includes a CPU or an internal memory. The display control circuit 20 reads the display data Da in the frame memory 30, notifies the data conversion circuit 40 of the subfield number Sb, or outputs an address signal Ad for designating the number of rows of the scanning lines to be selected for the scanning line driving circuit 130. In addition, the display control circuit 20 executes a process of determining a subfield width, which will be described later, to determine the width of each subfield when the response characteristic data of the pixel is obtained. The display control circuit 20 also determines whether the pixel is in the ON or OFF state in each subfield on a level-by-level basis with respect to each gradation level.

In the present embodiment, the response characteristic data corresponds to the temperature data detected by a temperature sensor (not shown). The temperature is closely associated with the optical response speed in the liquid crystal element because the response speed decreases as the temperature decreases. In addition to the temperature data, any other response characteristic data may be applicable if it can indicate the response speed in either a direct or indirect manner. For example, data directly indicating the response speed may be obtained from the upper-level circuit described above.

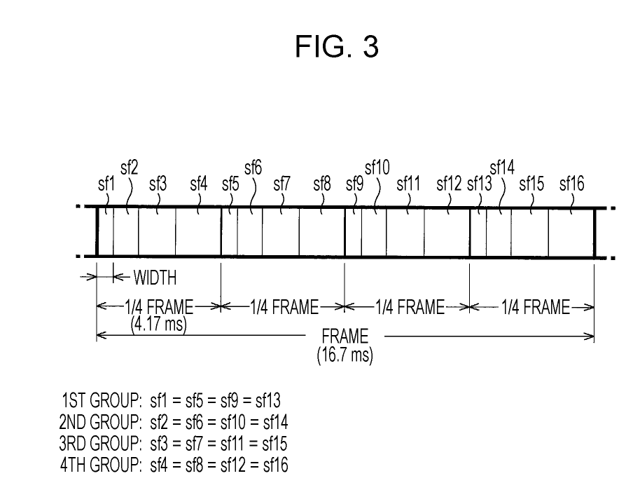

The subfields constituting a frame will be described with reference to FIG. 3.

Referring to FIG. 3, a frame is equally segmented into four segmentation periods, and at the same time, each segmentation period is also segmented into four subfields. As a result, in the present embodiment, a frame is segmented into 16 subfields. As will be described later, while in the present embodiment, 256 gradation levels are expressed, a frame is segmented into a smaller number of the subfields than the number of the gradation levels that can be expressed.

In FIG. 3, each segmentation period is denoted by a ¼ frame. In order to distinguish 16 subfields, they are denoted by sf1 to sf16 in a temporal order.

In the present embodiment, the time widths of subfields located in the same segmentation period are set to be equivalent. For example, the first subfields sf1, sf5, sf9, and sf13 of each segmentation period have the same width. Hereinafter, the first subfields in each segmentation period are referred to as a first group for convenience. Similarly, the second, third, and fourth subfields in each segmentation period are referred to as second, third, and fourth groups, respectively.

From the viewpoint of a pixel, an initiation point of each subfield is the time when a scanning line corresponding to the pixel is selected. Meanwhile, from the viewpoint of the entire operation of the display panel 100, the first scanning line may be used as a reference for convenience of descriptions.

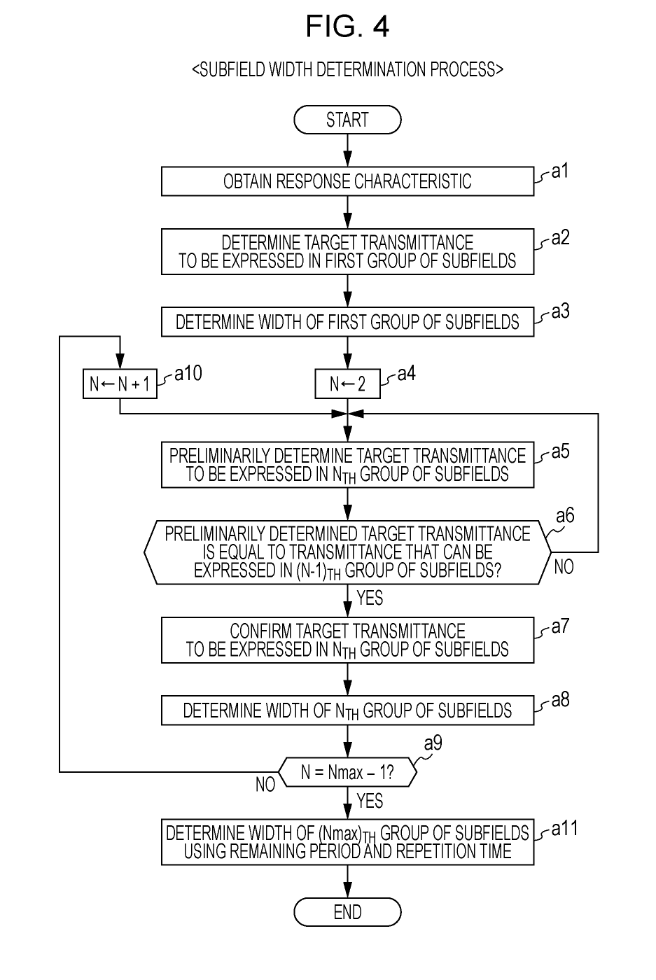

Subsequently, how to determine the width of the subfield in the present embodiment will be described. FIG. 4 is a flowchart illustrating a subfield width determination process for determining the width of the subfield.

The display control circuit 20 executes this subfield width determination process on a regular basis (e.g., in every 10 minutes).

The display control circuit 20 obtains the response characteristic data in step a1 when the subfield width determination process starts up. Subsequently, the display control circuit 20 determines a transmittance to be expressed (target transmittance) in the first group of subfields (sf1, sf5, sf9, and sf13) in step a2 as follows.

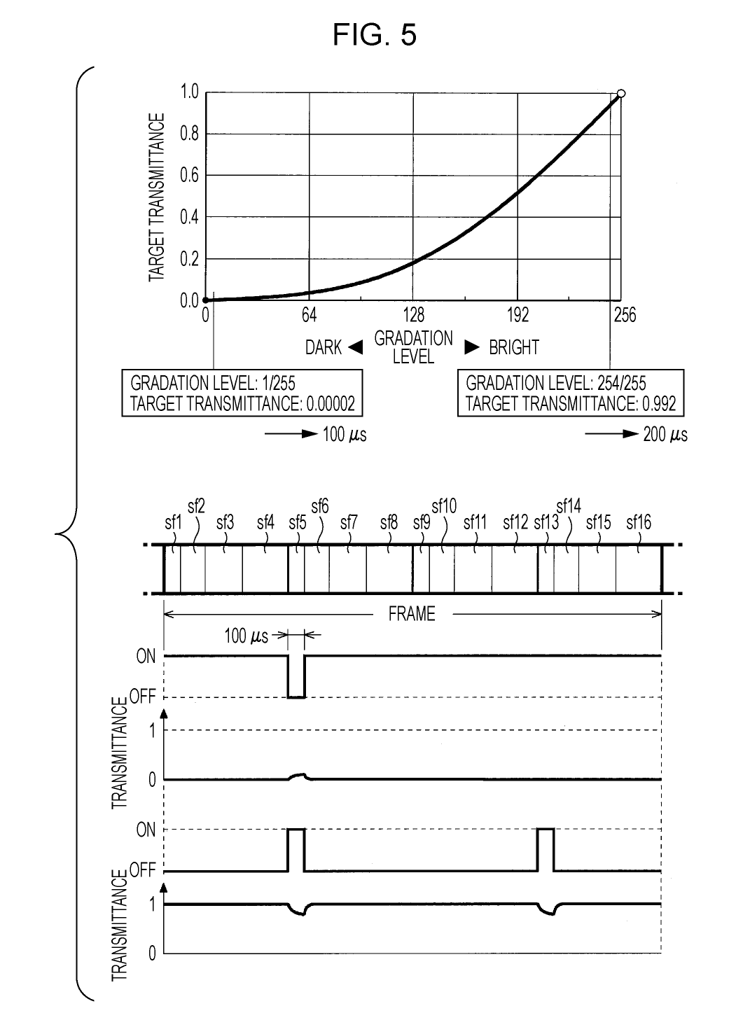

In the present embodiment, 256 gradation levels from “0” to “255” are displayed using a characteristic shown in FIG. 5. In this case, while the pixels to which a lowest gradation level “0” is designated are in the ON state for all the subfields sf1 to sf16, an integral transmittance in the liquid crystal elements of the corresponding pixels is set to “0” (0%) as a relative value supposing a frame is considered as a unit period. On the other hand, while the pixels to which a highest gradation level “255” is designated are in the OFF state for all the subfields sf1 to sf16, the transmittance of corresponding pixels at this moment is set to “1” (100%) as a relative value.

Under this assumption, first of all, the focus will be on the gradation level “1” (1/255) which is one level higher than the lowest gradation level and the gradation level “254” (254/255) which is one level lower than the highest gradation level. The gradation level “1” is expressed by setting the pixel to the OFF state for only one of the subfields having a narrowest width in a single frame and setting the pixel to the ON state for all the other subfields. The gradation level “254” is expressed by setting the pixel to the ON state for only one of the subfields having a narrowest width and setting the pixel to the OFF state for all the other subfields.

Herein, the width of the corresponding subfield obtained by setting the pixel to the OFF state for a certain subfield and setting the pixel to the ON state for all the other subfields in a single frame as described above is referred to as an OFF period, and the width of the corresponding subfield obtained by setting the pixel to the ON state for a certain subfield and setting the pixel to the OFF state for all the other subfields in a single frame is referred to as an ON period.

The display control circuit 20 obtains a value “0.00002” as the target transmittance of the gradation level “1” and a value “0.992” as the target transmittance of the gradation level “254” based on the graph of FIG. 5.

The display control circuit 20 determines which gradation level is to be expressed in the narrowest subfield based on a rising or falling response time of the liquid crystal. Specifically, first of all, the display control circuit 20 determines, through operations using a predetermined algorithm, a fact that, for example, out of a frame (16.7 ms), 100 μs is required for the OFF period in order to realize a target transmittance “0.00002” of the gradation level “1,” and 200 μs is required for the ON period in order to realize a target transmittance “0.992” of the gradation level “254” in a case where the pixel responds according to the response characteristics indicated in the obtained response characteristic data. Alternatively, the OFF or ON period may be obtained not by operations using an algorithm but by storing the results previously obtained through experiments as a table and then using this table.

Comparatively considering a fact that the OFF period required to realize the target transmittance of the gradation level “1” is 100 μs, and the ON period required to realize the target transmittance of the gradation level “254” is 200 μs, the display control circuit 20 determines a shorter period as the width of the first group of subfields. That is, the display control circuit 20 determines the width of the first group of subfields (sf1, sf5, sf9, and sf13) as 100 μs in step a3. In order to realize the target transmittance of the gradation level “1,” one (e.g., as shown in FIG. 5, only the subfield sf5) of the pixels in the first group of four subfields (sf1, sf5, sf9, and sf13) determined as 100 μs should be set to the OFF state, and pixels in all the other subfields should be set to the ON state. In order to realize the target transmittance of the gradation level “254”, out of four subfields, the pixel should be set to the ON state in two subfields (e.g., subfields sf5 and sf13 as shown in FIG. 5) and should be set to the OFF state in all the other subfields.

Then, in order to determine the width of the second group of subfields (sf2, sf6, sf10, and sf14), the display control circuit 20 sets an initial value of a variable N to “2” in step a4, and preliminarily determines any two values as the target transmittance of the Nth group of subfields in step a5. Since the variable N is set to “2” in this case, first and second target transmittances are preliminarily determined for the second group of subfields.

Subsequently, the display control circuit 20 determines whether or not the first target transmittance that has been preliminarily determined is equal to the transmittance obtained when the pixel is set to the ON state in all of the (N−1)th group of subfields and whether or not the second target transmittance that has been preliminarily determined is equal to the transmittance obtained when the pixel is set to the OFF state in all the (N−1)th group of subfields (in step a6).

Strictly to say, it is determined whether or not the difference between the target transmittance that has been preliminarily determined and the transmittance obtained when the pixel is set to the ON or OFF state in all of the (N−1)th group of subfields is within a threshold value. Herein, “the transmittance obtained when the pixel is set to the ON state in all the subfields of the (N−1)th group” means a transmittance obtained when the pixel is set to the ON state in all the subfields of the (N−1)th group, and the pixel is set to the OFF state in all the other subfields. Meanwhile, “the transmittance obtained when the pixel is set to the OFF state in all the subfields of the (N−1)th group” means a transmittance obtained when the pixel is set to the OFF state in all the subfields of the (N−1)th group, and the pixel is set to the ON state in all the other subfields.

In addition, the first target transmittance that has been preliminarily determined may be set to not the transmittance obtained when the pixel is set to the ON state in all the subfields of the (N−1)th group but a transmittance corresponding to a gradation level which is one level higher or lower than the transmittance obtained when the pixel is set to the ON state in all the subfields of the (N−1)th group. The second target transmittance may be similarly set to the first target transmittance.

By setting the target transmittance to the transmittance corresponding to the gradation level which is one level lower than the transmittance obtained when the pixel is set to the ON state in all the subfields of the (N−1)th group, it is possible to display the same transmittance in the subfields of either the Nth group or the (N−1)th group. As a result, it is possible to provide a margin during individual adjustment and combine the ON and OFF states of a plurality of subfields sf1 to sf16 having the same transmittance. Therefore, it is possible to select a combination by which a display artifact such as a false contour is hardly generated. The first and second target transmittances can be set to be higher or lower than the transmittance obtained when the pixel is set to the ON state in all the subfields of the (N−1)th group within a range that the gradation can be expressed without any failure.

In this case, since the variable N is set to “2”, it is determined whether or not the target transmittance of the second group of subfields that has been preliminarily determined is equal to the transmittance obtained when the pixel is set to the ON or OFF state in all the subfields of the first group.

If a result of this determination is “NO”, the display control circuit 20 returns the process to step a5 and change the preliminarily determined target transmittance to another value. If the processes of steps a5 and a6 are repeated, the determination result of step a6 becomes “YES” before long. At a time point when the determination result of step a6 becomes “YES”, the display control circuit 20 confirms the first and second target transmittances that have been preliminarily determined as the target transmittance to be expressed in the Nth group of subfields (in step a7).

That is, the first target transmittance to be expressed in a single subfield of the Nth group is set to the transmittance obtained when the pixel is set to the ON state in all the subfields of the (N−1)th group. The second target transmittance to be expressed in a single subfield of the Nth group is set to the transmittance obtained when the pixel is set to the OFF state in all the subfields of the (N−1)th group. In this case, since the variable N is set to “2”, the target transmittance to be displayed in the second group of subfields is set.

Subsequently, similar to the width of the first group of subfields in step a3, the display control circuit 20 sets the width of the Nth group of subfields to the OFF or ON period required to realize the target transmittance that has been confirmed (in step a8). That is, in a case where the pixel responds according to the response characteristics indicated in the response characteristic data, the display control circuit 20 separately obtains the OFF period required to realize the transmittance obtained when the pixel is set to the OFF state in all the subfields of the (N−1)th group, i.e., the second target transmittance and the ON period required to realize the transmittance obtained when the pixel is set to the ON state in all the subfields of the (N−1)th group, i.e., the first target transmittance so as to determine the shorter period as the width of the Nth group of subfields. In this case, with respect to the width of the second group of subfields, since the variable N is set to “2”, out of the OFF period required to realize the transmittance obtained when the pixel is set to the OFF state in all the subfields of the first group and the ON period required to realize the transmittance obtained when the pixel is set to the ON state in all the subfields of the first group, a shorter period is determined as the width of the second group of subfields.

In step a9, the display control circuit 20 determines whether or not the variable N set at this moment is smaller than that of the maximum value Nmax by “1.”

If the determination result is “NO,” the display control circuit 20 increments the variable N by “1” in step a10 and returns the process to step a5. Meanwhile, if the determination result is “YES,” the process is advanced to step all.

In the example of FIG. 3, since the maximum value Nmax is “4,” then it is determined whether or not the variable N at this moment is “3” in step a9. If the variable N is set to “2”, then the variable N is incremented to “3” in step a10. If steps a5 to a8 are executed when the variable N is “3,” then the width of the third group of subfields is determined. That is, the OFF period required to realize the transmittance obtained when the pixel is set to the OFF state in all the subfields of the third group and the ON period required to realize the transmittance obtained when the pixel is set to the ON state in all the subfields of the third group are separately obtained, and a shorter period is determined as the width of the third group of subfields.

In the state that the variable N is set to “3,” the determination result of step a9 becomes “YES”. Therefore, the display control circuit 20 determines the width of the (Nmax)th group of subfields in step all as follows. Specifically, the display control circuit 20 obtains a remaining period by subtracting from the frame period a period corresponding to all the subfields from the first group to the (Nmax−1)th group and dividing the remaining period by a repetition time so as to determine the division result as a subfield period of the (Nmax)th group.

Referring to the example of FIG. 3, the variable Nmax is “4,” and the repetition time is “4.” Therefore, the remaining period obtained by subtracting from the frame period the subfield period from all the subfields of the first to third groups is divided by “4,” and the division result is determined to be the width of the fourth group of subfields (sf4, sf8, sf12, and sf16).

If the transmittance that can be expressed using the fourth group of subfields is set to be smaller than (a dark side value) or larger than (a brighter side value) a value obtained by multiplexing, the transmittance obtained when the pixel is set to the ON state across the width obtained by summing one-by-one the subfields of the first to third groups are, by the repetition time (in the present embodiment, “4”), it is possible to achieve sufficient gradation accuracy and provide a margin in individual adjustment.

In step all, if the width of the (Nmax)th group of subfields is determined, it can be considered that the width of all the subfields is determined. Therefore, the display control circuit 20 terminates the subfield width determination process.

While, in the present embodiment, the subfield width determination process shown in FIG. 4 is executed on a regular basis, the response characteristic data may be obtained as an event or may be executed before the display operation immediately after the power is supplied.

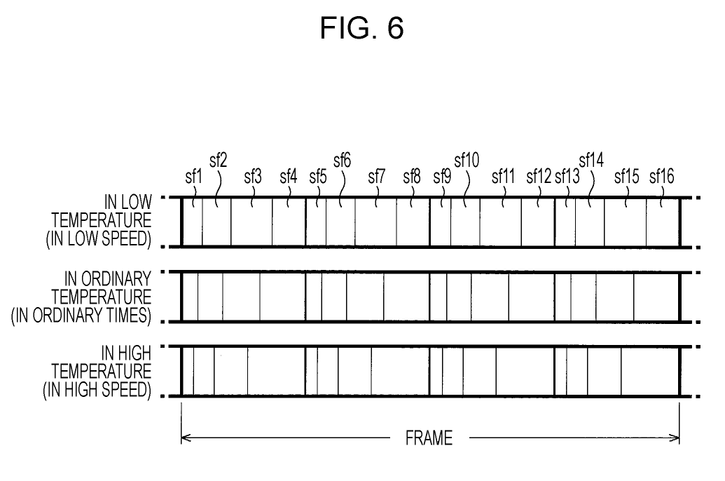

It is assumed that the OFF period for realizing a target transmittance of “0.00002” of the gradation level “1” at a temperature of 25° C. is 100 μs using the optical response speed of the liquid crystal element at a temperature of 25° C. as a reference speed. As the optical response speed of the liquid crystal element decreases, the OFF period for realizing the target transmittance “0.00002” increases. Therefore, if the response characteristic data indicate that the optical response speed of the liquid crystal element is lower than the reference speed, the OFF period for realizing the target transmittance “0.00002” of the gradation level “1” should be longer than 100 μs. For this reason, as shown in FIG. 6, the width of the first group of subfields (sf1, sf5, sf9, and sf13) should be lengthened. Accordingly, the width of the second group of subfields (sf2, sf6, sf10, and sf14) and the width of the third group of subfields (sf3, sf7, s11, and sf15) should be also lengthened. In this manner, since each of the widths of the first to third groups of subfields is lengthened out of the frame, the width of the fourth group of subfields (sf4, sf8, sf12, and sf16) obtained by dividing the remaining period is shortened to the contrary.

Meanwhile, if the response characteristic data indicates that the optical response speed of the liquid crystal element is higher than the reference speed, then the OFF period for realizing the target transmittance “0.00002” of the gradation level “1” should be shorter than 100 μs. Therefore, as shown in the same drawing, the width of the first group of subfields is shortened, and thereby, the widths of the second and third group of subfields are shortened, whereas the width of the fourth group of subfields is lengthened. In this manner, as the optical response speed of the liquid crystal element is later, the width of the first group of subfields is lengthened.

In the present embodiment, the widths of the first to third groups of subfields are lengthened (or shortened), and the width of the fourth group of subfields is shortened (or lengthened) to the contrary. However, the width of the first group of subfields may be lengthened (or shortened), and any one of the widths of the second to fourth groups of subfields may be shortened (or lengthened) to the contrary. As described above, the widths of the second to fourth groups of subfields are determined to include a margin for adjusting the width, and it is possible to adjust the widths of the subfields with respect to the variation of the response speed within a range of this margin.

Subsequently, the display control circuit 20 determines which one of the ON and OFF states is to be set to each gradation level with respect to each subfield in order to express all the gradation levels.

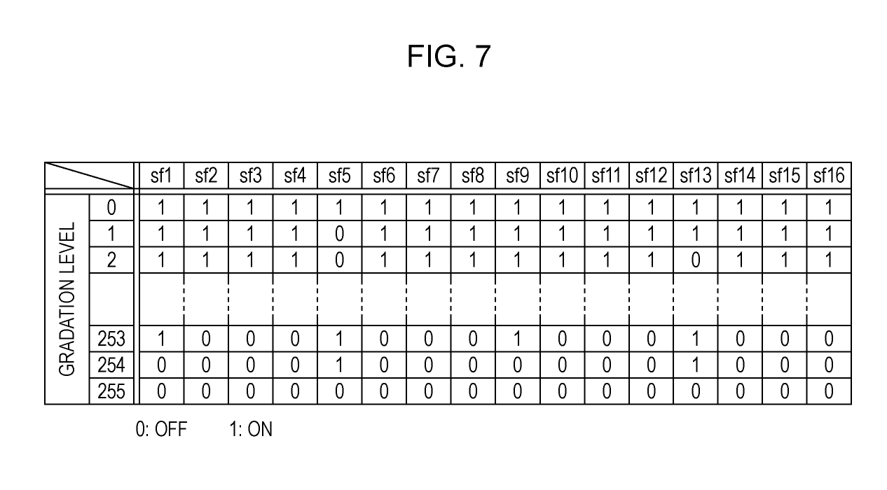

Referring to the aforementioned example, as shown in FIG. 7, first of all, if the gradation level is the minimum value “0”, the ON state corresponding to “1” is set for all the subfields sf1 to sf16. If the gradation level is the maximum value “255,” the OFF state corresponding to “0” is set for all the subfields sf1 to sf16. As described above, if the gradation level is “1,” then one of the subfields (sf1, sf5, sf9, and sf13) of the first group, for example, only the subfield sf5 is set to the OFF state corresponding to “0”. If the gradation level is “254,” two of the subfields of the first group, for example, the subfield sf5 and sf13 are set to the ON state corresponding to “1.”

Since the characteristic of the transmittance for the gradation level is a gamma characteristic which is downwardly swollen as shown in FIG. 5, the higher gradation level, the larger difference of transmittance between the gradation levels is produced. Meanwhile, in a case where the optical response speed of the liquid crystal element is slow, a relationship between the transmittance obtained when a single subfield is set to the ON or OFF state and the transmittance obtained when two subfields are set to the ON or OFF state is not a simple addition. For example, even when the target transmittance of the gradation level “2” is three times of the target transmittance of the gradation level “1,” only two subfields of the first group, for example, the subfields sf5 and sf13 may be set to the OFF state corresponding to “0” due to the response characteristics of the liquid crystal element. If the ON or OFF state is determined for each subfield in each gradation level as described above, the display control circuit 20 sets the determination result L in the data conversion circuit 40.

In this manner, the data conversion circuit 40, to which the determination result L is set, converts the display data Da read from the frame memory 30 into the data bit Db based on the gradation level and the subfield notified by the number Sb. When the scanning line is selected, the data bit Db is converted again into a data signal having the ON or OFF level by the data line driving circuit 140 and supplied to the 1st to 1024th data lines 114. While the scanning line is selected, the ON or OFF level of the data signal supplied to the data line 114 is applied to the pixel electrode of the liquid crystal element corresponding to the intersection between the corresponding selected scanning line and the data line so that the ON or OFF state is set depending on the data bit. Even when the selection of the scanning line is terminated, the liquid crystal element maintains the level applied to the pixel electrode. Therefore, the ON or OFF state corresponding to the data bit is maintained until the scanning line is selected again.

Therefore, in order to allow the liquid crystal element to have a state corresponding to the data bit for only a width of a certain subfield, a period after the scanning line is selected to write the data signal of the corresponding the data bit to the corresponding liquid crystal element until the corresponding scanning line is selected again may be used as the period of the corresponding subfield.

However, in a typical driving method in which the scanning lines are sequentially selected one-by-one e.g., in order of 1st, 2nd, 3rd, . . . and Nth rows, it is necessary to complete to select all the scanning lines within a period of a shortest subfield, and this is not realistic. In this regard, according to an embodiment of the invention, the scanning of the scanning lines is interlaced by the number of rows corresponding to the width of the subfield.

For example, in the present embodiment, it is assumed that the number of scanning lines is set to “768,” and the width of the first group of subfields (sf1, sf5, sf9, and sf13), which is considered as the narrowest width, is set to 100 μs. When the repetition cycle of the interlaced scanning is set to a ¼ frame (4.17 ms) which is a repetition unit of the subfields, all the scanning lines are selected for a writing corresponding to a single subfield within the corresponding ¼ frame, and a share of the first group of subfields within the ¼ frame may be set to be equal or approximate to a share of the number Ys of the interlaced scanning lines out of 768 rows. Therefore, it is recognized that the number Ys of the interlaced scanning lines for the first group of subfields may be 18 rows according to the following equation.

Ys=(100×10−6)(4.17×10−3)×768=18.4

In the aforementioned step a8, if it is determined that the width of the second group of subfields (sf2, sf6, sf10, and sf14) is 312 μs when the variable N is set to “2,” and the width of the third group of subfields (sf3, sf7, sf11, and sf15) is 1440 μs when the variable N is set to “3,” then, similarly, it is obtained that the number of interlaced scanning lines for the second group of subfields may be 100 rows, and the number of interlaced scanning lines for the third group of subfields may be 266 rows.

Furthermore, the number of the interlaced scanning lines for the fourth group of subfields (sf4, sf8, sf12, and sf16) is remaining 384 rows obtained by subtracting 18 rows, 100 rows, and 266 rows from 768 rows.

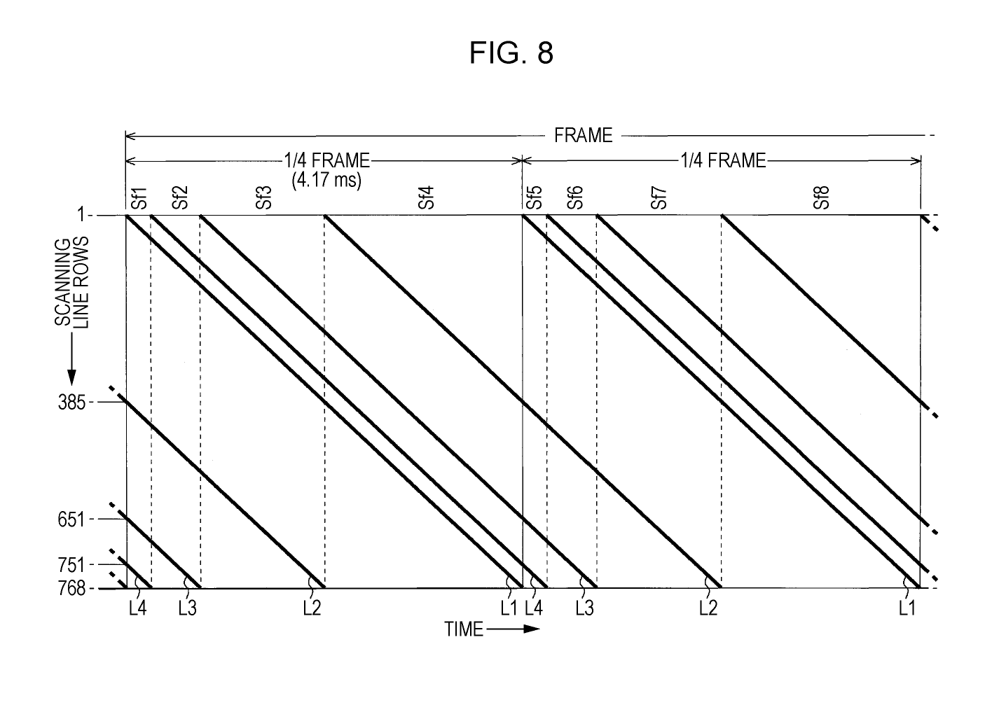

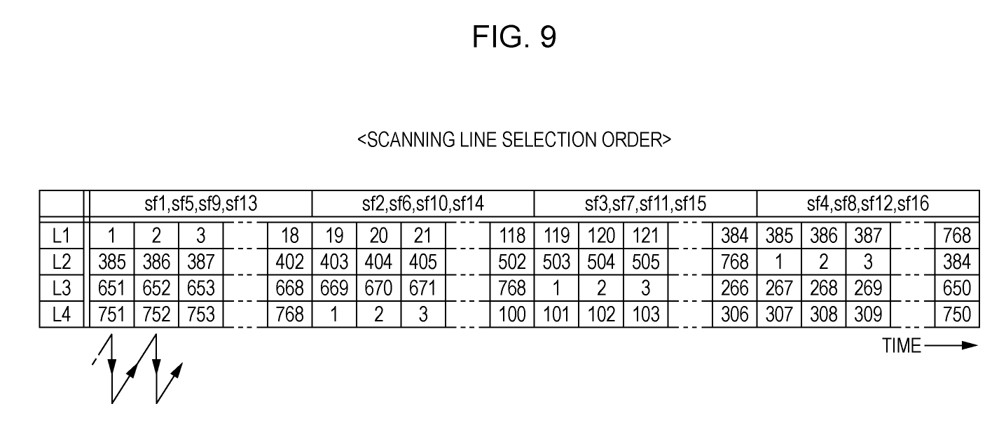

For this reason, as shown in FIGS. 8 and 9, the interlaced scanning of the scanning lines of the display panel 100 may be performed in every 384th, 266th, 100th, and 18th rows.

FIG. 8 illustrates a temporal change of the selected scanning lines when the ordinate axis denotes the 1st to 768th rows of the scanning lines, and the abscissa axis denotes time. When selection of the scanning lines is illustrated by “” (a black circle-shaped dot), since the scanning lines are interlaced, while the temporal change of the scanning lines may be illustrated as discontinuous dots “” in practice, they are illustrated as continuous dots (a solid line) plotted in a right-down diagonal direction in the drawing for simplicity. FIG. 9 is a table illustrating the row number of the scanning lines selected by the scanning line driving circuit 130 in each subfield. In other words, FIG. 9 is a table showing the order of the scanning lines designated by the address signal Ay.

Referring to FIGS. 8 and 9, assuming that the start point of the selected scanning line is set to the 1st row at the beginning of a frame, the interlaced scanning is performed in the order of 1st, 385th, 651st, and 751st rows. Then, by shifting the start point by one row to the 2nd row, the interlaced scanning is performed in the order of 2nd, 386th, 652nd, and 752nd rows. Then, similar operations are repeated until the interlaced scanning is performed in the order of 18th, 402nd, 668th, and 768th rows by shifting the start point to the 18th row.

At this moment, when the scanning line L1 associated with the start point is selected, a data signal corresponding to the data bit for the subfield sf1 is written. When the scanning line L2 interlaced by 384 rows with respect to the scanning line L1 is selected, a data signal of the data bit for the subfield sf16 before one frame is written. Similarly, when the scanning line L3 interlaced by 266 rows with respect to the scanning line L2 is selected, a data signal of the data bit for the subfield sf15 before one frame is written. When the scanning line L4 interlaced by 100 rows with respect to L3 is selected, a data signal of the data bit for the subfield sf14 before one frame is written.

After the interlaced scanning is performed by shifting the start point to the 18th row, the interlaced scanning is performed in the order of 19th, 403rd, 669th, and 1st rows by shifting the start point to the 19th row. Then, similar operations are repeated until the interlaced scanning is performed in the order of 118th, 502nd, 768th, and 100th rows by shifting the start point to the 118th row. In this case, when the scanning lines L1, L2, and L3 are selected, the writing is performed according to the data bit similarly. However, when the scanning line L4 is selected, the writing is performed according to the data bit of the subfield sf2 of the current frame.

After the interlaced scanning is performed by shifting the start point to the 118th row, the interlaced scanning is performed in the order of 119th, 503rd, 1st, and 101st rows by shifting the start point to 119th row. Then, similar operations are repeated until the interlaced scanning is performed in the order of 384th, 768th, 266th, and 306th rows by shifting the start point to the 384th row. In this case, when the scanning lines L1, L2, and L4 are selected, the writing is performed according to the data bit similarly. However, when the scanning line L3 is selected, the writing is performed according to the data bit of the subfield sf3 of the current frame.

After the interlaced scanning is performed by shifting the start point to the 384th row, the interlaced scanning is performed in the order of 385th, 1st, 267th, and 307th rows by shifting the start point to the 385th row. Then, similar operations are repeated until the interlaced scanning is performed in the order of 768th, 384th, 650th, and 750th rows by shifting the start point to the 768th row. In this case, when the scanning lines L1, L3, and L4 are selected, the writing is performed according to the data bit similarly. However, when the scanning line L2 is selected, the writing is performed according to the data bit of the subfield sf4 of the current frame.

Then, if similar operations are repeated four times for the ¼ frame, pixels in the 1st to 768th rows are turned on or off according to the gradation level only during a time period corresponding to the subfields sf1 to sf16. Therefore, it is possible to display gradation when they are succeeded in a frame.

FIGS. 8 and 9 illustrate the interlaced scanning when the widths of the first, second, and third groups of subfields are set to 100 μs, 312 μs, and 1440 μs, respectively. When it is indicated that the response characteristics are changed based on the response characteristic data, the display control circuit 20 changes the widths of each subfield as described above. Therefore, the interlacing order of the scanning lines would be accordingly changed from FIGS. 8 and 9.

According to the present embodiment, the response characteristics of the pixel (e.g., a liquid crystal element) is changed according to the temperature, the time width of the subfields sf1 to sf16 is determined (changed) in consideration of the corresponding response characteristic. Therefore, it is possible to complete the interlaced scanning without damaging expression characteristics of each gradation level. Even when the optical response is different between a plurality of display panels, it is possible to match expression characteristics of each gradation level by supplying each display panel with individual response characteristic data from an upper-level circuit or the like.

In the aforementioned embodiment, in a case where a frame is defined by synchronization signals supplied from an upper-level circuit, even when the time width of the frame is changed for some reasons, it is possible to complete the interlaced scanning without damaging expression characteristics of each gradation level by changing the widths of each subfield with respect to the changed frame. For example, when the time width of a frame is lengthened as the vertical scanning frequency is reduced, the widths of the first, second, and third groups of subfields are changed to be lengthened, and the width of the fourth group of subfield is changed to be shortened. Simultaneously, a determination result L determined using the widths of subfields after the change is set in the data conversion circuit 40. As a result, it is possible to complete the interlaced scanning without damaging expression characteristics of each gradation level.

While the display control circuit 20 determines the widths of each subfield by executing the subfield width determination process shown in FIG. 4 in the aforementioned embodiment, the widths of each subfield may be determined by creating a table containing the widths of each subfield previously determined for each of a plurality of response characteristic data and reading, from the table, values corresponding to the changed response characteristic data when the obtained response characteristic data are changed.

The liquid crystal element in the pixel may be reflective type without limiting to the transmissive type. The display element is not limited to the liquid crystal element, but may include any element turned on or off according to the data bit. For example, the invention may be applicable to an organic EL (electroluminescent) element, an electrophoretic element (so called electronic paper), a mirror element that is inclined according to the ON and OFF states and reflects the incident light to a predetermined direction in either the ON or OFF location, or the like.

### Electronic Device

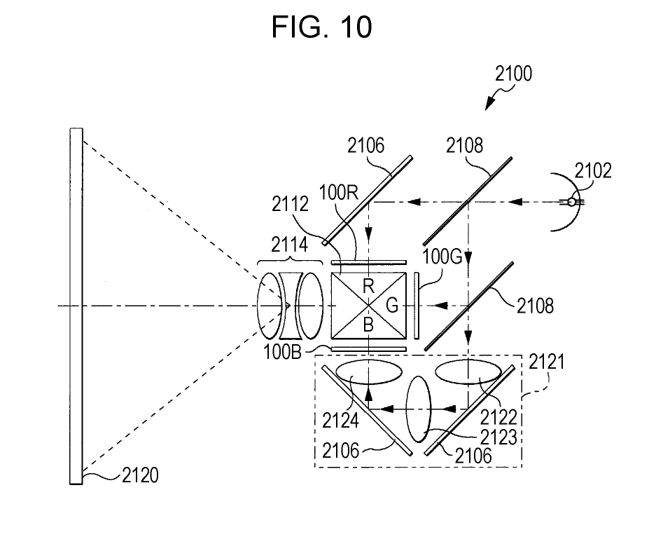

Subsequently, as an example of an electronic device using the aforementioned electro-optical apparatus, a projector which uses the electro-optical apparatus as a light valve will be described. FIG. 10 is a plan view illustrating a construction of the projector.

Referring to FIG. 10, the inside of the projector 2100 is provided with a lamp unit 2102 made of a white light source such as a halogen lamp. The projection light emitted from this lamp unit 2102 is separated into three elementary colors R (red), G (green), and B (blue) through three internal mirrors 2106 and two dichroic mirrors 2108 and guided to the light valves 10R, 10G, and 10B corresponding to each element color. Since the blue light has a longer optical path in comparison with the red or green light, it is guided through a relay lens system 2121 including an incident lens 2122, a relay lens 2123, and an emission lens 2124 in order to prevent loss thereof.

The projector 2100 includes three electro-optical apparatuses having the display panel 100 according to red, green, and blue colors. The display data corresponding to the red, green, and blue colors are supplied from each of the upper-level circuits and stored in the frame memory. The light valves 100R, 100G, and 100B have similar constructions to those of the aforementioned display panel 100 and are driven for each subfield using data bits corresponding to each of the red, green, blue colors.

The light beams modulated by the light valves 100R, 100G, and 100B are incident to the dichroic prism 2112 from three directions. In the dichroic prism 2112, the red and blue light beams are refracted by 90 degrees and the green light beam travels straight.

Accordingly, after images of each color are combined, a color image is projected onto the screen 2120 through the projection lens 2114.

Since the light beams corresponding to the elementary colors R, G, and B are incident to the light valves 100R, 100G, and 100B, respectively, through the dichroic mirror 2108, it is unnecessary to provide a color filter. While the image transmitted through the light valves 100R and 100B is reflected by the dichroic prism 2112 and then projected, the image transmitted through the light valve 100G is directly projected. Therefore, the horizontal scanning directions of the light valves 100R and 100B are opposite to the horizontal scanning direction of the light valve 100G so that images inverted in right and left sides are displayed.

In addition to the electronic device described with reference to FIG. 10, the invention may be applicable to other electronic devices such as a television set, a view finder type or monitor direct view type video tape recorder, a car navigation apparatus, a pager, an electronic notepad, an electronic calculator, a word processor, a workstation, a video phone, a POS terminal, a digital still camera, a mobile phone, or devices having a touch panel. Needless to say, the aforementioned electro-optical apparatus may be applicable to such various electronic devices.

The entire disclosure of Japanese Patent Application No. 2009-029922, filed Feb. 12, 2009 is expressly incorporated by reference herein.

What is claimed is:

1. A method of driving an electro-optical apparatus,
the method comprising:
including segmenting a time width of a field into a plurality of subfields, the subfields within the field having different widths, and expressing desired gradation using a plurality of the subfields by applying an ON level for setting a pixel to an ON state or an OFF level for setting the pixel to an OFF state to the pixel in each subfield,
obtaining response characteristic data representing response characteristics of the pixel; and
setting a width of the subfield, which makes the pixel to be the ON or OFF state, to be lengthened when the response characteristic data indicate that a response of the pixel is delayed.

2. A method of driving an electro-optical apparatus,
the method comprising:
including segmenting a time width of a field into a plurality of subfields, and expressing a desired gradation level using a plurality of the subfields by applying an ON level for setting a pixel to an ON state or an OFF level for setting the pixel to an OFF state to the pixel in each subfield,
obtaining response characteristic data representing response characteristics of the pixel; and
setting a time width of the subfield, which makes the pixel to be the ON or OFF state, to be lengthened when the response characteristic data indicate that a response of the pixel is delayed.

3. The method according to claim 1, wherein the width of the subfield to be lengthened is determined based on an optical state obtained by setting the pixel to the ON state for a corresponding subfield and to the OFF state for other subfields or an optical state obtained by setting the pixel to the OFF state for a corresponding subfield and to the ON state for other subfields according to the response characteristics indicated by the obtained response characteristic data.

4. The method according to claim 1, wherein, when the obtained response characteristic data indicate that the response of the pixel is delayed, any subfield other than the subfield to be lengthened among a plurality of the subfields is shortened.

5. An electro-optical apparatus, the electro-optical apparatus comprising:
a display control circuit that segments a time width of a field into a plurality of subfields and expresses desired gradation using a plurality of the subfields by applying an ON level for setting a pixel to an ON state or an OFF level for setting the pixel to an OFF state to the pixel in each subfield, and the display control circuit that obtains response characteristic data representing response characteristics of the pixel and sets a time width of the subfield, which makes the pixel to be the ON or OFF state, to be lengthened when the response characteristic data indicate that a response of the pixel is delayed.

6. An electronic device comprising an electro-optical apparatus according to claim 5.
